(19) United States
(12) Patent Application Publication
(10) Pub. No.: US 2015/0234987 A1
(43) Pub. Date: Aug. 20, 2015

(54) System and Method for Processing Healthcare Information

(71) Applicant: UPMC, Pittsburgh, PA (US)

(72) Inventors: James Hansel Laing, Glenshaw, PA (US); Casey John Helfrich, Pittsburgh, PA (US); Robert B. Meek, JR., Pittsburgh, PA (US); Rasu Bickram K Shrestha, Allison Park, PA (US); Kathryn Minardo Scott, Aspinwall, PA (US); Meera Rajaram, Sewickley, PA (US); Rebecca Lynn Kaul, Pittsburgh, PA (US)

(21) Appl. No.: 14/625,975

(22) Filed: Feb. 19, 2015

Related U.S. Application Data
(60) Provisional application No. 61/942,203, filed on Feb. 20, 2014.

(51) Int. Cl. G06F 19/00

(52) U.S. Cl. CPC G06F 19/324; G06F 19/322

(57) ABSTRACT

A system for processing healthcare information includes: a patient clinical context module including a patient-user relationship model, a medical knowledge database, and an applied workflow execution model; the patient clinical context module being configured to retrieve information from a plurality of data sources and to use the patient-user relationship model, the medical knowledge database, and the applied workflow execution model to produce output information relevant to a patient; and a user display configured to display the output information in a longitudinal view of health data for the patient aggregated from the plurality of data sources. A method for processing healthcare information that can be implemented by the system is also disclosed.

CROSS-REFERENCE TO A RELATED APPLICATION

This application claims the benefit of U.S. Provisional Patent Application Ser. No. 61/942,203, filed Feb. 20, 2014 and titled “System And Method For Processing Healthcare Information”, which is incorporated herein by reference.

### BACKGROUND

1. Field of the Invention

Embodiments of the present invention relate to information systems and methods implemented by those systems, and more particularly to systems and methods for processing healthcare information.

2. Description of the Related Art

Healthcare information is commonly stored and processed using a plurality of separate data storage, processing and viewing systems. For example, a large hospital system may be spread across a wide geographical area and may comprise numerous hospitals with separate systems for data storage, and for processing and viewing healthcare information. Additionally, many hospitals have implemented an ad hoc combination of a variety of systems optimized for individual uses. For instance, different Electronic Medical Records (EMRs) may be used for different clinical specialties and settings, task-specific systems for imaging and diagnostic procedures, etc.

This plurality of systems makes it difficult to have an authoritative summary of the patient history and treatment. It would be desirable to have a single system that allows caregivers to quickly “get up to speed” with a patient's health story.

### SUMMARY

In a first aspect, embodiments of the invention provide a system for processing healthcare information that includes: a patient clinical context module including a patient-user relationship model, a medical knowledge database, and an applied workflow execution model; the patient clinical context module being configured to retrieve information from a plurality of data sources and to use the patient-user relationship model, the medical knowledge database, and the applied workflow execution model to produce output information relevant to a patient; and a user display configured to display the output information in a longitudinal view of health data for the patient aggregated from the plurality of data sources.

In another aspect, embodiments of the invention provide a method for processing healthcare information including: supplying information from a plurality of data sources to a patient clinical context module including a patient-user relationship model, a medical knowledge database, and an applied workflow execution model; using the patient-user relationship model, the medical knowledge database, and the applied workflow execution model to produce output information relevant to a patient; and displaying the output information in a longitudinal view of health data for the patient aggregated from the plurality of data sources.

### BRIEF DESCRIPTION OF THE DRAWINGS

FIG. 1 is a block diagram of elements of a healthcare information system that can be implemented in accordance with an embodiment of the invention.

FIG. 2 is a block diagram of elements of a healthcare information system showing legacy system components.

### DETAILED DESCRIPTION

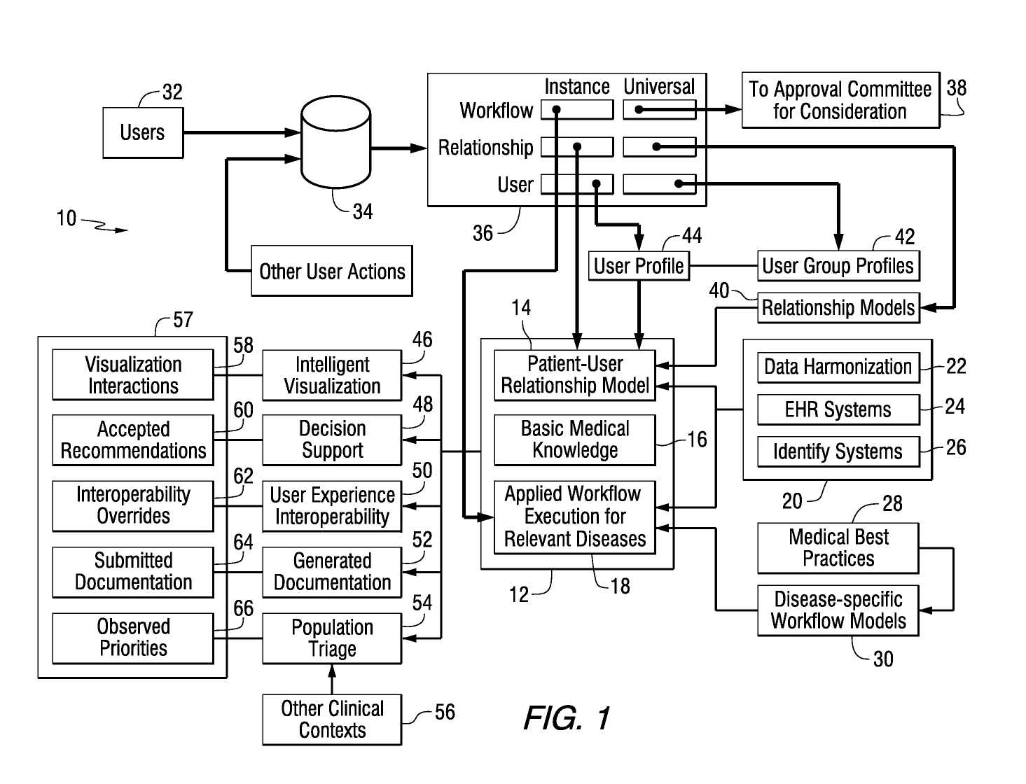

FIG. 1 is a block diagram of a healthcare information system 10 that may be implemented in accordance with an embodiment of the invention. The system of FIG. 1 can provide information that allows caregivers to quickly “get up to speed” with a patient's health story. For example, in various embodiments, the system can convey salient details of a patient's health record to a clinician to provide a longitudinal view of patient health data, aggregated from a variety of different data sources into an easy-to-understand visualization.

The system of FIG. 1 includes a patient clinical context module 12 that interacts with a plurality of information sources to produce outputs that allow users to navigate between a converged, visual view of the patient record and a plurality of underlying transactional systems including patient records and/or clinical orders.

The patient clinical context module 12, in this example, includes a patient-user relationship model 14, a basic medical knowledge database 16, and an applied workflow execution for relevant diseases or conditions 18.

The patient clinical context is informed by a legacy context, including Electronic Health Record (EHR) data and identity data about both the patient and the user. A repository of workflow models can provide templates for the workflows executing in the patient clinical context.

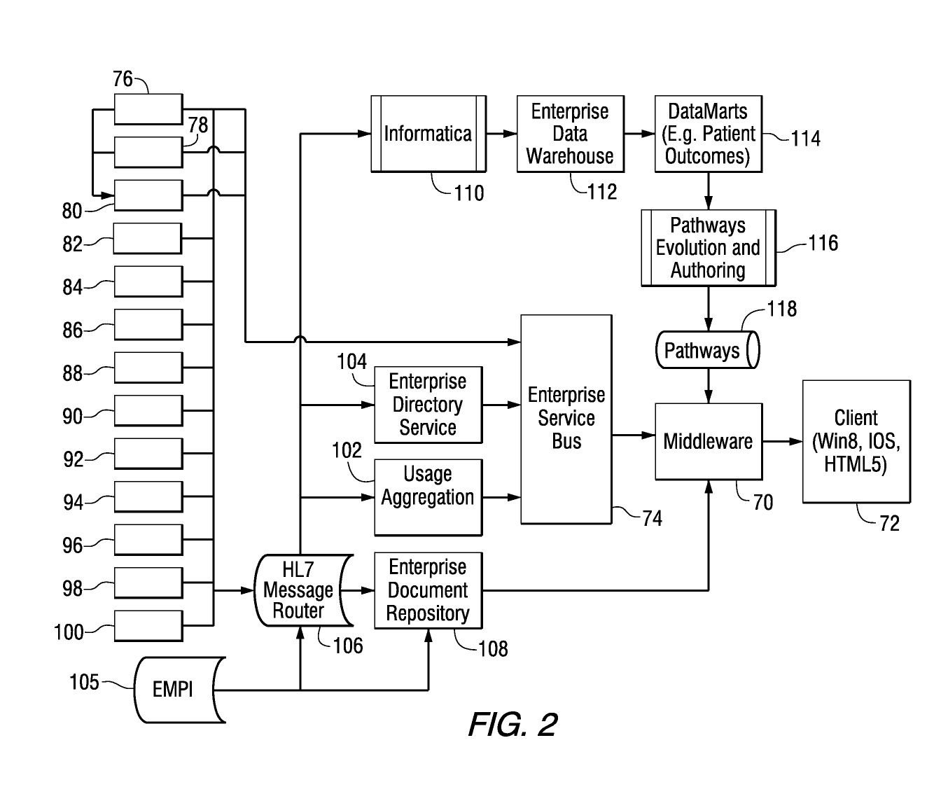

The patient clinical context module 12 receives information from legacy systems 20, more fully described in FIG. 2. The legacy systems can include, for example, data harmonization 22, EHR systems 24, and identity systems 26. The patient clinical context module 12 can also receive information relating to medical best practices 28 and disease or condition specific workflow models 30.

In the embodiment of FIG. 1, a plurality of users 32 can interact with user experience analytics 34 to provide information to a machine learning module 36. The machine learning module can include universal workflow, relationship, and user information, as well as workflow, relationship, and user information relating to a particular instance, for example a particular patient.

The universal workflow information can be transmitted to approval committees for consideration as shown in block 38. Universal relationship information can be transmitted to relationship models 40. Universal user information can be transmitted to user group profiles 42.

The particular instance workflow information can be transmitted to the applied workflow execution in the patient clinical context. The particular instance relationship information can also be transmitted to the patient-user relationship model in the patient's clinical context. The particular instance user information can also be transmitted to a user profile 44. Information from the user profile 44 can be transmitted to the patient's clinical context.

The patient's clinical context can be used to provide various types of information to users of the system. Such information can include intelligent visualization 46, decision support 48, user experience interoperability 50, generated documentation 52, and/or population triage 54. Other clinical contents can also be provided as shown in block 56.

The users can receive the information on a user device, such as a tablet computer or other device with a display for displaying the information. The display can be an interactive display allowing the user to navigate through the information by manipulating the display, and to submit requests or provide other information to the patient's clinical context module.

The information that is provided to the users may prompt numerous user actions, including for example, visualization interactions 58, accepted recommendations 60, interoperability overrides 62, submitted documentation 64, and observed priorities 66.

In various embodiments of the system, raw data can be sourced from a wide variety of previously existing (i.e., legacy) clinical data sources. FIG. 2 is a block diagram of elements of a healthcare information system that includes legacy system components.

In FIG. 2, the functions illustrated in FIG. 1 are implemented in the blocks labeled 70 and 72, wherein block 70 includes middleware that receives information from a plurality of legacy information systems and block 72 includes application software that may run on client platforms or user devices, which may include for example, Windows, iOS, and HTML operating systems. The middleware receives information on an enterprise service bus 74. The enterprise service bus receives information from a plurality of legacy information systems 76, 78, 80, 82, 84, 86, 88, 90, 92, 94, 96, 98 and 100, as well as from a usage data aggregation system 102 and an enterprise directory service 104. The legacy information systems can include for example, electronic health records, diagnostic information, medical image information, etc.

An enterprise master patient index 105 supplies information to an HL7 message router 106 and an enterprise document repository 108. The HL7 message router also receives information from the legacy information systems. The HL7 message router sends information to the enterprise document repository 108, the usage aggregation data system 102, and the enterprise directory service 104. The HL7 message router also sends information to an informatics system 110, which sends data to an enterprise data warehouse 112 and a plurality of datamarts 114. The datamarts send information to a pathways evolution and authoring module, which send information to a pathways module 118 and then to the middleware. The middleware also receives information from the enterprise document repository.

The system can be configured to proactively customize a user's experience in a clinical scenario to deliver the most appropriate care in an efficient and effective way. In the example of FIG. 1, a modular system leverages both contextual information and user behavior to proactively drive intelligent clinical actions.

The system of FIG. 1 can be configured to provide the following applications: 1) intelligent visualizations with highlights on points of interest, 2) actionable decision support that is tailored to the specific clinical scenario, 3) appropriate system-guided transitions among a suite of applications, 4) automatic generation of clinical documentation based on workflow traversed, and 5) clinically-informed prioritization among a population of patients that the user is responsible for. While a user is most likely a physician, the system can also be used by other caregivers and interested parties, including a patient himself or herself. In some embodiments, applications 1-3 can be implemented as modules within a delivery framework that runs on the user devices. For example, the production delivery implementation can be an Extension in the Chrome browser.

These 5 applications can be implemented using a plurality of models that represents a patient clinical context. The patient clinical context can include one or more actively-executing disease-specific workflow models (e.g. Acute Congestive Heart Failure, Diabetes Lifestyle Management), described generally herein as workflow modeling. This instance of these workflows can be mediated, and conflicts between models resolved, with the application of a repository of basic medical knowledge. Additionally, a model of the patient-user relationship provides important context that allows the system to tailor the patient clinical context to be specific to the role, specialty, class, and clinical history of that particular patient and user combination.

Intelligent visualization provides flexible visualization tools that allow clinicians to quickly gain insight into a patient's overall health story and drill into specific details. Using the chronology as the primary organizing mechanism, the visualizations can highlight commonalities in disparate, irregular datasets to build an easily understood clinical picture. Specific foci may include a longitudinal “timeline” of health data across categories as well as a rolling visualization to provide a summary of recent trends and changes.

Decision support can be implemented as a dedicated module that takes discrete clinical data and application usage input of contextual content (e.g. username, patient, application, time, derived intent, command, and/or query) and produces a model of probable workflows with confidence models as an output. These workflows can be used by downstream systems to pro-actively create alerts, data views, and analytical visualizations that are appropriate for the user's probable tasks at future points in the workflow.

User experience interoperability provides the user with an integrated, multi-application workflow that utilizes the context of the clinician and patient along with a derived understanding of the user's intent. This workflow leverages context-sharing technologies that can be engineered into the underlying platform to permit the user to seamlessly transition between disparate applications. This basic context-sharing includes patient and user identities and can be extended to include specific destinations and actions. This functionality presents the user with the proper clinical application, and more specifically targeted functionality within that application, that will be needed to perform the next steps in the patient's care. The intent of the user can be determined by the system without it being explicitly declared.

As users utilize the system in the course of providing patient care, the system continuously monitors user actions, data views and general navigational activity and provides generated documentation. When clinical documentation about the patient is desired (for example the creation of a progress note) the system recalls user activity over a specified period of time and automatically generates objective documentation derived from previous user actions. This auto-generated documentation can be used as a basis for patient-specific clinical documentation.

Population triage continually monitors other patients' clinical contexts and suggests workflow priorities that allow the clinician to address patients whose conditions warrant immediate attention.

Workflow modeling is an application of computer-interpretable guidelines, such as PROforma and similar tools. These represent a clinically-validated, asynchronous pathway for treating a condition (e.g. administer a drug until the patient achieves a certain state, continually monitor a lab). These tools separate out medical knowledge (e.g. how much of a given drug to give, how to evaluate the likelihood of a given diagnosis, etc.) from the higher level workflow (e.g. administer therapeutic medication, confirm diagnosis, etc.) modules.

In the example of FIG. 1, the workflow models can be used to inform the patient clinical context and the associated 5 applications. The workflow may also be subject to refined understanding from the machine learning subsystem. In contrast, the medical knowledge is delivered specifically via the decision support application and exists outside of the machine learning loop, subject to approval by committees of clinicians who evaluate the latest in evidence-based medicine. By using an understanding of the relevant clinical tasks, expressed in the workflow model, the system can proactively provide the right user experience.

Machine learning can be implemented using current industry standard techniques and solutions. Hadoop based systems may be used to provide classification, clustering, frequency mining, and recommendations. While instantiations of MapReduce that address these goals are maturing, more classical data analysis (fixed function reports, and statistically relevant histograms and clustering) may also be used. The use of machine learning and rule-based decision support provides a spectrum of workflow tools from low level calculators to high level cognitive analysis and natural language recommendations.

The system can be configured to continually learn and adapt based on the user actions performed within the five applications. For instance, clicking on a given aspect of visualization is noted in a user experience (UX) analytics database as an interest in that particular aspect of that visualization. Whether this interest is user-specific, patient-specific, or workflow-specific can be determined by a machine learning solution (described above) and the resulting aggregation of user preferences can be applied to further enhance a particular patient's clinical context as well as future patients' clinical contexts. Additional user actions can be captured, across all five of the applications described, that indicate the appropriateness of those particular context-informed customizations.

Unstructured clinical documentation alone (i.e., natural language notes) can be produced in a variety of legacy systems. Discrete data from electronic medical records (EMRs) and other systems are gathered (e.g. batched daily and/or in real-time depending on the specific capabilities of the particular system) by an enterprise data warehouse, which has fixed function data marts (e.g. patient outcomes) that are optimized for various query workloads.

In addition to clinical information, meta-data about usage and encounter data representing the various interactions between providers, patients, and the software used in the encounter, can also be logged and made available. Real-time system access to data is abstracted behind an enterprise service bus. Ideally, all data produced by the enterprise can be made available for processing by the context management and clinical decision support systems.

The system can receive inputs based on user activities (e.g. both user interface and data) combined with traditional clinical context (e.g. user id, patient id, application id), user context (e.g. in hospital, at bedside, at workstation), and user modality (e.g. mobile, desktop, wearable).

Mobile, touch-enabled software can be used to give users quick access to the most important patient information, with visualization for at-a-glance understanding. In one embodiment, a tablet-based platform pulls patient data from a variety of electronic health record silos and puts them together in a meaningful and visually appealing record. For example, using a Windows-based tablet, the system can allow users to move seamlessly between existing legacy systems and new applications and provides users with an evidence-based treatment guide that includes lists of medications, dosages, infusions, and trend analysis.

Various embodiments of the system can be implemented using a modular approach that drives a context-aware clinical experience, providing clinicians with an intelligent navigation framework across a suite of clinical applications. The described embodiments can provide an intelligent consolidated view of key patient health data (extracted from a variety of clinical systems) as well as meaningful visualization of the longitudinal patient record. The longitudinal data display and targeted navigation to legacy systems enables clinicians to engage deeply with the patient, and their health history, across multiple devices (desktop, tablet, and mobile) without interruption to their workflow. Patient information can be organized into “clinical pathways,” where the most relevant information is always at the physician's fingertips, rather than hidden in the multiple screens and tabs of one or more underlying electronic health records systems.

The user device can provide the single sign-on and data integration technologies that allow the system to pull information from multiple underlying EHRs and clinical systems, with the ability to navigate smoothly between the converged, visual view of the patient record and the underlying transactional systems for recording patient records and clinical orders.

In some embodiments, the EHR can be treated as an embedded component of the system, accessible with gesture control. For example, a swipe gesture can be used to switch between full screen clinical applications on the display.

The system permits existing clinical tools and newly-developed software applications to interoperate seamlessly within the patient and user context. The underlying enabling technology supports the continual development of powerful future applications. The development framework allows third-party vendors to create complimentary applications that leverage the user experience and interoperability of the underlying technologies. This creates an endless possibility of potential future enhancements, beyond the base product, that will keep pace with the ever-changing needs of the health care market.

For example, to facilitate the development of future applications, programmatic access to the healthcare and meta-data elements used by the base platform can be provided to licensed third party developers to create additional modules of functionality that extend the capabilities of the application set delivered on the user devices. In other words, the same data that drives implementations of the described system can be made available for future functionality that may not be developed by the original authors. By using the same information and meta-data as the base system, data consistency and user experience consistency can be maintained. Data that is used on application program interfaces in one embodiment can be securely re-used at the application level to create new views for particular clinical workflows, while maintaining data parity with a default set of capabilities.

The future applications can participate in the ecosystem in two ways. First, when implemented as modules within the delivery framework itself for a more cohesive user experience, which does run on the user device, or as a CCOW compliant independent application participant on the user device.

The various elements of the system can be implemented using known computer or processing apparatus that is programmed or otherwise configured to provide the functions illustrated in FIGS. 1 and 2.

In general, it will be apparent to one of ordinary skill in the art that some of the embodiments as described hereinabove may be implemented using software, firmware, and/or hardware. The software code or specialized control hardware used to implement some of the present embodiments is not limiting of the present invention. For example, the embodiments described hereinabove may be implemented in computer software using any suitable computer software language. Such software may be stored on any type of suitable non-transitory computer-readable medium or media such as, for example, a magnetic or optical storage medium. Thus, the operation and behavior of the embodiments are described without specific reference to the actual software code or specialized hardware components. It is understood that artisans of ordinary skill would be able to design software and control hardware to implement the embodiments of the present invention based on the description herein with only a reasonable effort and without undue experimentation.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and, therefore, a more detailed description of such elements is not provided herein.

In various embodiments of the present invention disclosed herein, a single component may be replaced by multiple components, and multiple components may be replaced by a single component, to perform a given function or functions. Except where such substitution would not be operative in practical embodiments of the present invention, such substitution is within the scope of the present invention.

While several aspects of the invention have been described herein, it should be apparent, however, that various modifications, alterations and adaptations to those aspects may occur to persons skilled in the art with the attainment of some or all of the advantages of the present invention. The disclosed embodiments are therefore intended to include all such modifications, alterations and adaptations without departing from the scope and spirit of the present invention.

What is claimed is:

1. A system for processing healthcare information comprising:
a patient clinical context module including a patient-user relationship model, a medical knowledge database, and an applied workflow execution model;
the patient clinical context module being configured to retrieve information from a plurality of data sources and to use the patient-user relationship model, the medical knowledge database, and the applied workflow execution model to produce output information relevant to a patient; and
a user display configured to display the output information in a longitudinal view of health data for the patient aggregated from the plurality of data sources.

2. The system for processing healthcare information of claim 1, wherein the output includes one or more of:
visualization information, decision support information, user experience interoperability information, generated documentation, and population triage information.

3. The system for processing healthcare information of claim 1, wherein:
the applied workflow execution model provides templates for the workflows executing in the patient clinical context module.

4. The system for processing healthcare information of claim 1, wherein:
the user display is an interactive display allowing user to control information presented on the display and to enter information for the patient clinical context module.

5. The system for processing healthcare information of claim 1, wherein:
the plurality of data sources include transactional systems for recording patient records, identity data, and clinical orders.

6. The system for processing healthcare information of claim 1, wherein:
the plurality of data sources include Electronic Health Record (EHR) data and identity data.

7. The system for processing healthcare information of claim 1, wherein:
the applied workflow execution model includes a disease or condition specific workflow model.

8. The system for processing healthcare information of claim 1, wherein:
the patient clinical context module receives information relating to medical best practices and disease specific workflow models.

9. A method for processing healthcare information comprising:
supplying information from a plurality of data sources to a patient clinical context module including a patient-user relationship model, a medical knowledge database, and an applied workflow execution model;
using the patient-user relationship model, the medical knowledge database, and the applied workflow execution model to produce output information relevant to a patient; and
displaying the output information in a longitudinal view of health data for the patient aggregated from the plurality of data sources.

10. The method for processing healthcare information of claim 9, wherein the output includes one or more of:
visualization information, decision support information, user experience interoperability information, generated documentation, and population triage information.

11. The method for processing healthcare information of claim 9, wherein:
the applied workflow execution model provides templates for the workflows executing in the patient clinical context module.

12. The method for processing healthcare information of claim 9, wherein:
the user display is an interactive display allowing user to control information presented on the display and to enter information for the patient clinical context module.

13. The method for processing healthcare information of claim 9, wherein:
the plurality of data sources include transactional systems for recording patient records, identity data, and clinical orders.

14. The method for processing healthcare information of claim 9, wherein:
the plurality of data sources include Electronic Health Record (EHR) data and identity data.

15. The method for processing healthcare information of claim 9, wherein:
the applied workflow execution model includes a disease specific workflow model.

16. The method for processing healthcare information of claim 9, wherein:
the patient clinical context module receives information relating to medical best practices and disease specific workflow models.

17. The method for processing healthcare information of claim 9, further comprising:
monitoring other patients' clinical contexts and suggests workflow priorities that allow the clinician to address patients whose conditions warrant immediate attention.

18. The method for processing healthcare information of claim 9, further comprising:
providing programmatic access to the healthcare information and meta-data elements related to the healthcare information to allow the creation of additional modules of functionality that extend the capabilities of applications delivered on user devices.
